(19) United States
(12) Patent Application Publication
(10) Pub. No.: US 2005/0024681 A1
(43) Pub. Date: Feb. 3, 2005

(54) Systems and methods for scanning multiple objects

(76) Inventors: Justin A. Tehrani, Broomfield, CO (US); Scott C. Baggs, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/632,417

(22) Filed: Aug. 1, 2003

(51) Int. Cl. G06K 15/02; G06F 3/12; H04N 1/387; H04N 1/393

(52) U.S. Cl. 358/1.18; 358/450; 358/1.2; 358/451

(57) ABSTRACT

In accordance with an embodiment of the present invention, a method comprises scanning a plurality of objects and generating a plurality of scanned images, selecting a predefined template for arranging at least two of the scanned images on a single page, and automatically arranging at least two of the scanned images on said single page based at least in part on the selected template.

### BACKGROUND OF THE INVENTION

The use of scanners has substantially increased over the years. Scanners are increasingly being used to scan different kinds of objects, such as documents, photographs, negatives, transparencies and/or the like. Many scanners comprise or may be used with an automatic document feeder for scanning a document comprising multiple sheets. These scanners usually receive a first sheet from the feeder and scan the sheet. The remaining sheets in the document feeder are each scanned one after the other. Once scanned, the entire document is stored as a single file comprising multiple pages. Newer scanners comprise or may be used with an automatic photo feeder for scanning multiple photographs. These scanners receive a first photograph from the feeder, scan the photograph, and store an image of the scanned photograph. The remaining photographs in the photo feeder are each scanned and stored in a similar manner.

Typically each scanned object is saved as a separate page. This process is undesirable especially when scanning photographs because most photographs are typically smaller in size than an entire page. If the user desires to print or place multiple photographs on the same page, the user must either manually arrange the photographs on the platen prior to scanning or use an image editing software application after the photographs have been scanned. Both these methods are cumbersome and require extra effort from the user.

### SUMMARY OF THE INVENTION

In accordance with an embodiment of the present invention, a method comprises scanning a plurality of objects and generating a plurality of scanned images, selecting a predefined template for arranging at least two of the scanned images on a single page, and automatically arranging at least two of the scanned images on said single page based at least in part on the selected template.

In accordance with another embodiment of the present invention, a method comprises receiving an input specifying a number of scanned images to be arranged in a predefined area, generating the specified number of scanned images by scanning an equal number of objects, selecting a predefined template from a plurality of different templates for arranging the specified number of scanned images in the predefined area, and automatically arranging the specified number of scanned images in the predefined area according to the predefined template.

### BRIEF DESCRIPTION OF THE DRAWINGS

For a more complete understanding of the present invention, reference is now made to the following descriptions taken in connection with the accompanying drawings in which:

FIG. 1 is a perspective view of an exemplary image capture device that may use embodiments of the present invention to advantage;

FIG. 2 is a flowchart of a method for scanning multiple objects in accordance with an embodiment of the present invention;

FIG. 3 is a flowchart of a method for scanning multiple objects in accordance with an alternative embodiment of the present invention; and

FIG. 4 illustrates an exemplary arrangement of three scanned images on a page.

### DETAILED DESCRIPTION OF THE DRAWINGS

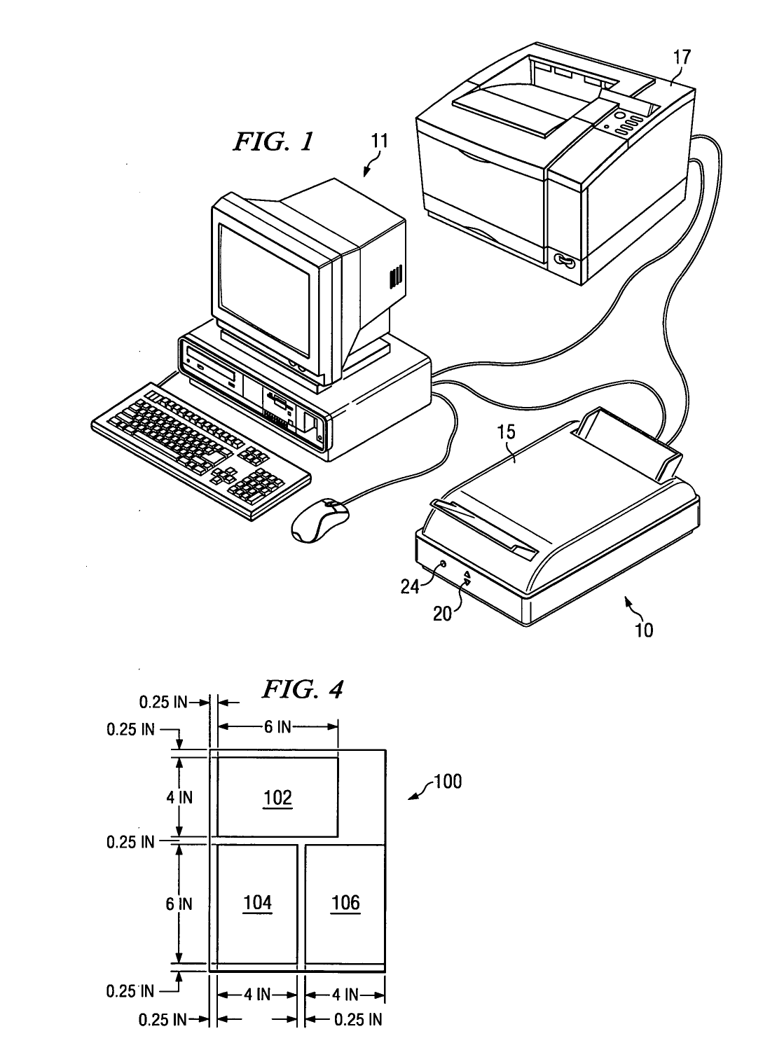

The preferred embodiment of the present invention and its advantages are best understood by referring to FIGS. 1 through 4 of the drawings, like numerals being used for like and corresponding parts of the various drawings.

FIG. 1 is a perspective view of an exemplary image capture device 10 in the form of a scanner, such as a flatbed scanner. If desired, image capture device 10 may instead be part of a multi-function device, a copier, a facsimile machine, or another machine that generates a digital image for storage, transmission or further processing. The terms “image capture device,” “flatbed scanner,” and “scanner” are used interchangeably herein. Scanner 10 includes a platen against which an object to be scanned, such as a document, a photograph, a negative, a transparency, and/or the like, may be placed. For the sake of convenience, the illustrated embodiment of the present invention will be described herein with reference to photographs, although the teachings of the illustrated embodiment of the present invention may be used for scanning other types of objects.

Scanner 10 may comprise a feeder 15, for example an automatic document feeder (ADF) or an automatic photo feeder (APF). Feeder 15 may be any feeder now known or later developed for automatically feeding a plurality of objects to scanner 10 for scanning, although feeder 15 may be used to feed a single object to scanner 10. Feeder 15 covers the platen and the object placed thereon. Scanner 10 may be coupled to a computer system 11 to facilitate control and operation of scanner 10. Scanner 10 may be coupled to a printing device 17 either directly or via computer system 11. Coupling between scanner 10, computer system 11, printing device 17, or other electronic device can be a direct coupling (such as shown in FIG. 1) or an indirect coupling, such as a wireless connection or connections through other electronic devices.

Preferably, a carriage disposed in scanner 10 supports one or more scanning devices or subsystems, such as a light source, an internal optical system and a photosensitive device (not explicitly shown). The light source radiates light that passes through the platen and reflected off the object placed thereon. The reflected light is collected by the internal optical system and directed onto the photosensitive device. The photosensitive device collects the light reflected from the object. The collected light is converted into pixel data values for each pixel and recorded.

An embodiment of the present invention is a system and method for scanning multiple objects that allows images of a plurality of the scanned objects to be automatically arranged or placed in a predefined area, for example on a single page. The predefined area may be of any shape, such as rectangular, oval, circular, etc. In accordance with an embodiment of the present invention, predefined templates are provided preferably based on the number of images to be placed in the predefined area, the standard sizes of the objects, for example photographs, to be scanned, e.g. 3×5, 4×6, 5×7, etc. The predefined templates may be stored in a memory device associated with scanner 10 or computer system 11. Preferably, the user specifies the number of images to be arranged in the predefined area. Based on the number of images to be arranged in the predefined area and/or the size of the scanned objects, one of the predefined templates is automatically selected. The scanned images are arranged in the predefined area in accordance with the selected template to create a combined image. The combined image may be saved for future processing. If desired, image data of the combined image may be transmitted to a printing device for printing Thus, the user may create copies of objects, such as photographs, with each page comprising images of the specified number of objects, without having to manually arrange the objects on a single page.

If desired, one or more control buttons, for example a toggle switch 20 and a photoprint button 24 may be provided on scanner 10. Toggle switch 20 may be used by the user to select the number of objects to be arranged in the predefined area. The user may simply place the objects in feeder 15, select or specify the number of objects to be arranged in the predefined area using toggle switch 20, and activate photoprint button 24 to scan the objects placed in feeder 15 and arrange them in the predefined area.

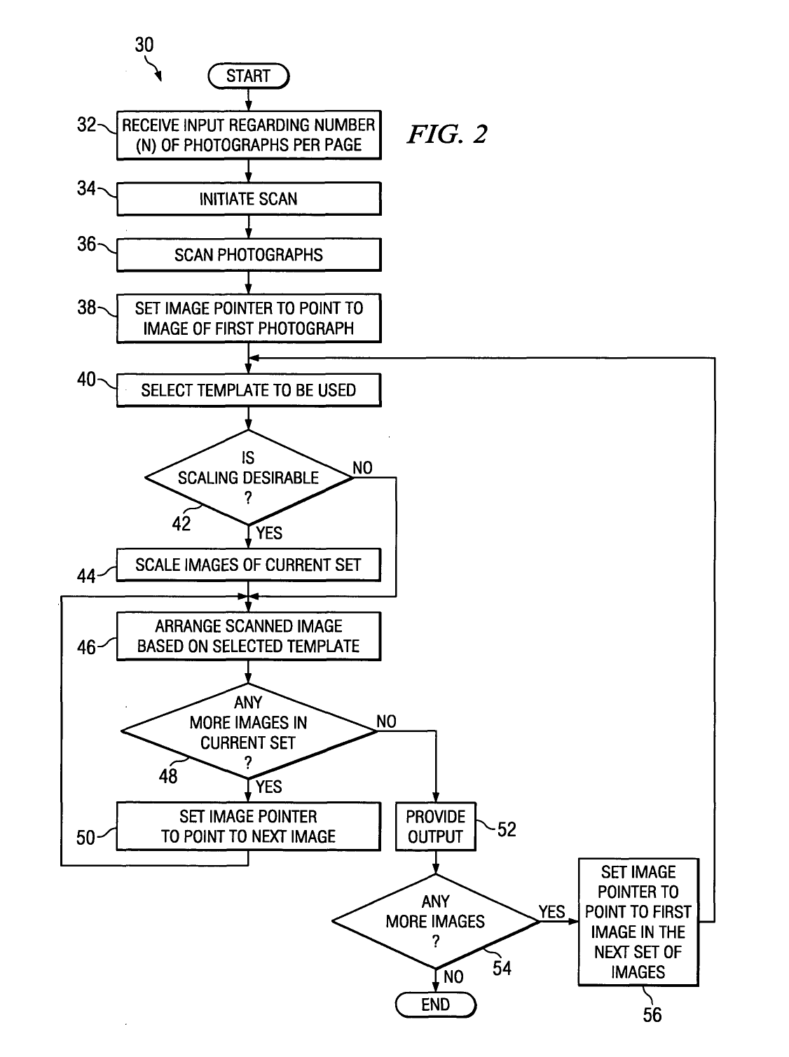

FIG. 2 is a flowchart of a method 30 for scanning multiple objects in accordance with an embodiment of the present invention. For simplicity of description, the illustrated embodiments of the present invention will be described hereinafter with reference to “photographs.” In block 32, input regarding the number (N) of photographs to be arranged in a predefined area, for example a page, is received. For simplicity of description, the illustrated embodiments of the present invention will be described hereinafter with reference to a page as being the predefined area. However, if desired, the predefined area may occupy a portion of a page or may be multiple pages. The user may select the number of photographs to be arranged on the same page using toggle switch 20 and activate photoprint button 24 to initiate a scan operation.

In block 34, the scan operation is initiated. In block 36, photographs placed in feeder 15 are scanned to generate scanned images of the photographs. Preferably, all photographs placed by the user in feeder 15 are scanned in block 36. Once the photographs have been scanned, the scanned images may be stored in a storage medium associated with scanner 10 or computer system 11.

Blocks 38 through 56 are used to arrange the scanned images so that there are images of N scanned photographs on each page. A plurality of predefined templates that may be used for arranging the photographs are provided. In an exemplary embodiment only one of the predefined templates is used for arrangement of the photographs in the predefined area. In another exemplary embodiment, more than one of the predefined templates is used for arrangement of the photographs in the predefined area. If desired, the predefined templates are preferably software templates that specify or define how the scanned images are to be arranged on each page. The software templates may be simple text files, scripts and/or the like. The predefined templates may be preloaded into scanner 10 or may be loaded into scanner 10 or computer system 11 by the user. Preferably, templates are defined for photographs of different standard sizes. For each standard size there are multiple templates, each template corresponding to the number of images to be arranged on the page. For example, for 4×6 photographs, a template may be provided for arranging two photographs on the same page; a second template may be provided for arranging three photographs on the same page; a third template may be provided for arranging four photographs on the same page, and so on. A template comprises positioning information for each image. Such positioning information can comprise a degree of rotation, X-offset, Y-offset, and/or the like, that may be used to arrange multiple images on the same page. Information contained in an exemplary template-for arranging three 4×6 photographs on a 8 ½×11 page is shown in Table A.

TABLE A

| Image | Rotation | X-offset | Y-offset |
|---|---|---|---|
| Number | (degree) | (inch) | (inch) |
| 1. | 90 | 0.25 | 0.25 |
| 2. | 0 | 0.25 | 4.5 |
| 3. | 0 | 4.5 | 4.5 |

FIG. 4 illustrates an exemplary arrangement of multiple images according to the template of Table A. In FIG. 4, three scanned images 102, 104 and 106 are arranged on a page 100. In the template of Table A, it is assumed that the photographs are placed lengthwise in feeder 15 for scanning. According to the above template and as illustrated in FIG. 4, in order to arrange the images on page 100, the first image, for example image 102, is rotated by ninety degrees and placed on the page so that the top-left corner of the image is at an X-offset of 0.25 inches and a Y-offset of 0.25 inches from the top-left corner of the page; an X-offset of 0.25 inches and a Y-offset of 4.5 inches is applied to the second image, for example image 104; and an X-offset of 4.5 inches and a Y-offset of 4.5 inches is applied to the third image, for example image 106. The offsets are preferably measured from the top-left corner of the page. The template of Table A defines a border of at least 0.25 inches to be provided around each image arranged on the page.

Referring back to FIG. 2, in block 38, an image pointer is set to point to the image of the first photograph scanned. In block 40, a template from the plurality of predefined templates is selected, preferably automatically. The selection of the template is preferably based on one or more of the following: the size of the scanned photographs, the number of photographs to be arranged on each page, size of the X-offset, size of the Y-offset, shape of the predefined area, and/or the like. For example, a determination may be made as to whether any of the plurality of templates correspond to the specified value of N, i.e. the number of photographs to be arranged in the predefined area. If none of the templates correspond to the specified value of N, then an error indication may be provided to the user. Otherwise, a determination may be made as to whether any of the templates corresponding to the specified value of N also correspond to the size of the scanned photographs. If there is one predefined template that corresponds to both the size of the scanned photographs and the specified value of N, then in block 40 that template is selected. If none of the templates that correspond to the selected value of N also correspond to the size of the scanned photographs, then the template that corresponds to the next smaller size of the scanned photographs for the user-selected value of N is selected. If there are multiple predefined templates that correspond to both the size of the scanned photographs and the specified value of N, then any of those templates may be selected based on predetermined criteria. In an exemplary embodiment, the predetermined criteria is the value of the offsets. In another exemplary embodiment, priority may be assigned to the templates and this priority may be used to select one of the multiple predefined templates. The selected template is used for arranging images of N photographs on the same page. These N photographs form a current set. A “set” is preferably a set of photographs or images of photographs to be arranged in a predefined area.

In block 42, a determination is made as to whether scaling of the scanned images is desirable. Scaling may be desirable, for example, if in block 40 a template corresponding to a smaller size of photograph than the size of the scanned photographs was selected. The selection of the template to be used and the determination of whether scaling is desirable is intended to ensure that to the extent possible, the original size of the image is maintained. Preferably, scaling is applied only if it is not possible to arrange the user specified number of photographs on the same page.

If in block 42 it is determined that scaling is not desirable, then the process starting at block 46 may be executed. Otherwise, in block 44, the scanned images are scaled so that the specified number of images may fit on the same page. Preferably, only those scanned images which are to be arranged on the same page are scaled.

In block 46, the scanned image pointed to by the image pointer is arranged in the predefined area based at least in part on the selected template. Preferably, the scanned image is arranged such that it does not overlap other images in the predefined area. The method described hereinabove with reference to Table A and FIG. 4 may be used for arranging the image pointed to by the image pointer in the predefined area. If the image pointed to by the image pointer is the first image in the current set, then a combined image comprising the scanned image is created. Otherwise, the combined image is updated to include the scanned image pointed to by the image pointer.

In block 48, a determination is made as to whether any more images in the current set are to be arranged in the predefined area. This determination may be made, for example, by comparing the value of N to the actual number of scanned images that have been arranged in the combined image. If there are additional images to be arranged, then in block 50, the image pointer is set to point to the next image and the process starting at block 46 to arrange the next image may be executed. Otherwise, in block 52, an output is provided. Using a graphical user interface associated with computer system 11, the user may specify in advance the type of output desired. For example, the user may specify that the combined image be stored as an image file in computer system 11. If desired, the user may specify that image data of the combined image be automatically transmitted to printing device 17 for printing.

In block 54, a determination is made as to whether there are any more scanned images to be arranged. If there are additional images to be arranged, then in block 56, the image pointer is set to point to the first image in the next set of images and the process starting at block 40 to select the template to be used for the next set of images may be executed. The template may be the same or different as the previous set depending on the size of the photographs. If in block 54, it is determined that there are no more scanned images to be arranged, then the process ends.

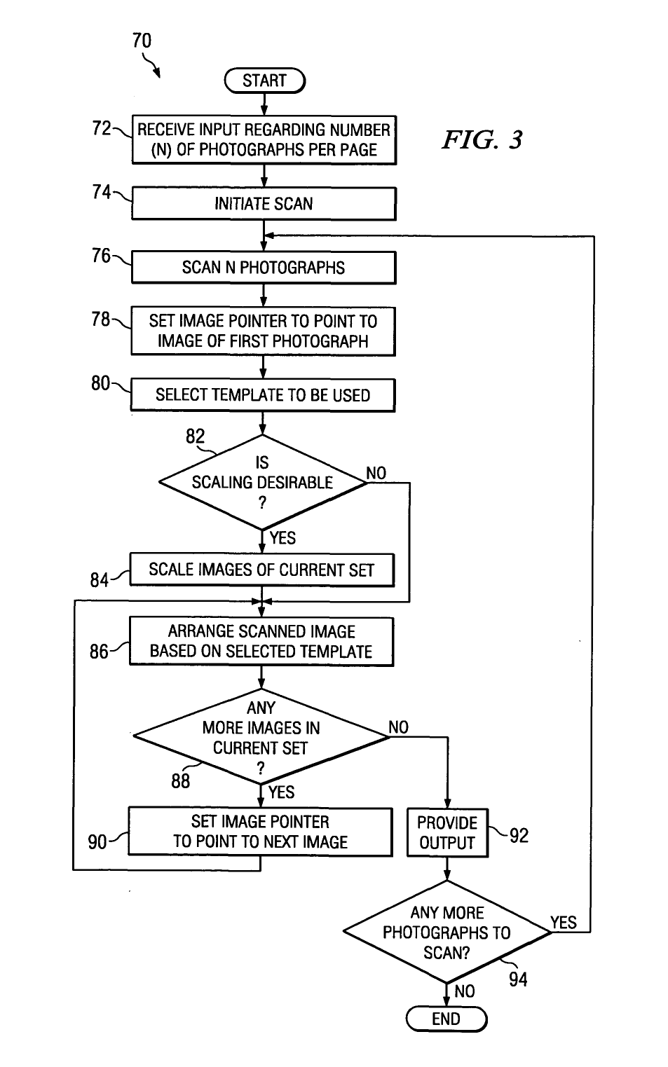

FIG. 3 is a flowchart of a method 70 for scanning multiple objects in accordance with an alternative embodiment of the present invention. In this embodiment, the photographs are scanned in sets of N. In block 72, input regarding the number (N) of photographs to be arranged in the predefined area is received. In block 74, a scan operation is initiated. In block 76, photographs placed in feeder 15 are scanned to generate scanned images of the photographs. Preferably, N number of photographs from feeder 15 are scanned in block 74. Once the photographs have been scanned, the scanned images may be stored in a storage medium associated with scanner 10 or computer system 11. These N images or photographs form a current set.

In block 78, an image pointer is set to point to the image of the first photograph of the set of photographs scanned. In block 80, a template from the plurality of predefined templates is selected preferably automatically. The selection of the template is preferably based on one or more of the following: the size of the scanned photographs and the number of photographs to be arranged on each page.

In block 82, a determination is made as to whether scaling of the scanned images is desirable. Scaling may be desirable, for example, if in block 80 a template corresponding to a smaller size photograph than the size of the scanned photographs was selected. If scaling is not desirable, then the process starting at block 86 may be executed. Otherwise, in block 84, the scanned images of the current set are scaled so that they may fit on the same page.

In block 86, the scanned image pointed to by the image pointer is arranged in the predefined area based at least in part on the selected template. In block 88, a determination is made as to whether any more images in the current set are to be arranged in the predefined area. This determination may be made, for example, by comparing the value of N to the actual number of scanned images that have been arranged in the combined image. If there are additional images to be arranged, then in block 90, the image pointer is set to point to the next image and the process starting at block 86 to arrange the next image may be executed. Otherwise, in block 92, an output is provided. Using a graphical user interface associated with computer system 11, the user may specify the type of output desired. For example, the user may specify that the combined image be stored as an image file in computer system 11. If desired, the user may specify that image data of the combined image be automatically transmitted to printing device 17 for printing.

In block 94, a determination is made as to whether there are any more photographs to be scanned. If there are additional photographs to be scanned, then the process starting at block 76 to scan the next N photographs may be executed. If there are less than N photographs remaining to be scanned, then the actual number of photographs scanned in block 76 is less than N.

In exemplary embodiments of the present invention, the user may print multiple photographs on the same page without having to manually manipulate the scanned images of the photographs.

Although the illustrated embodiments have been described herein with reference to using templates that correspond to standard sizes of photograph, the invention is not so limited. If desired, templates that correspond to sizes other than standard sizes of photographs may be used. The advantage of using templates that correspond to standard sizes of photographs is that printed copies of the photographs may be used with existing albums or frames that correspond to standard sized photographs. The advantage of using templates that correspond to sizes other than the standard size of photographs is that it provides greater flexibility to the user in terms of the size of the printed photographs.

The present invention may be implemented in software, hardware, or a combination of both software and hardware. The software and/or hardware may reside on image capture device 10 or computer system II. If desired, part of the software and/or hardware may reside on image capture device 10 and part of the software and/or hardware may reside on computer system 11.

If desired, the different functions discussed herein may be performed in any order and/or concurrently with each other. Furthermore, if desired, one or more of the above described functions may be optional or may be combined without departing from the scope of the present invention.

1. A method, comprising:
scanning a plurality of objects and generating a plurality of scanned images;
selecting a predefined template for arranging at least two of said scanned images on a single page; and
automatically arranging at least two of said scanned images on said single page based at least in part on said selected template.

2. The method of claim 1, wherein said automatically arranging comprises automatically arranging at least two of said scanned images for printing on said single page.

3. The method of claim 1, wherein said automatically arranging comprises automatically arranging at least two of said scanned images for storage as said single page, said single page being part of an image file.

4. The method of claim 1, further comprising:
automatically transferring image data related to said single page to a printing device;
and
automatically printing said at least two of said scanned images on a single page.

5. The method of claim 1, further comprising receiving an input specifying a number of said scanned images to be arranged on said single page.

6. The method of claim 1, wherein said selecting comprises selecting said template based at least in part on a user-specified number of said scanned images to be arranged on said single page.

7. The method of claim 1, wherein said selecting comprises selecting said template based at least in part on a size of at least one of said plurality of objects.

8. The method of claim 1, further comprising scaling said scanned images prior to said automatically arranging step.

9. The method of claim 1, wherein said automatically arranging comprises automatically arranging said at least two scanned images based at least in part on an offset information specified by said selected template.

10. The method of claim 1, wherein said automatically arranging comprises automatically arranging said at least two scanned images based at least in part on orientation information specified by said selected template.

11. The method of claim 1, wherein said automatically arranging comprises:
automatically rotating at least one of said at least two scanned images to fit said at least two scanned images on said single page; and
automatically arranging said at least two scanned images on said single page such that said at least two scanned images do not overlap.

12. A method, comprising:
receiving an input specifying a number of scanned images to be arranged in a predefined area;
generating said specified number of scanned images by scanning an equal number of objects;
selecting a predefined template from a plurality of different templates for arranging said specified number of scanned images in said predefined area; and
automatically arranging said specified number of scanned images in said predefined area according to said predefined template.

13. The method of claim 12, wherein said specified number of scanned images are arranged to create a combined image on a single page.

14. The method of claim 13, further comprising automatically rotating at least one of scanned images to create said combined image.

15. The method of claim 12, wherein said selecting step comprises automatically selecting said predefined template by a device selected from the group consisting of a scanner and a computer.

16. The method of claim 12, wherein said selecting comprises selecting said template based on a size of at least one of said scanned objects and said specified number of scanned images.

17. The method of claim 12, wherein said predefined area is non-rectangular in shape.

18. The method of claim 12, wherein said predefined area is rectangular in shape.

19. An image capture device, comprising:
application logic operatively associated with said image capture device and operable to:
scan a plurality of objects and generate a plurality of scanned images;
automatically select a predefined template for arranging at least two of said scanned images on a single page; and
automatically arrange at least two of said scanned images on said single page based at least in part on said selected template.

20. The image capture device of claim 19, wherein said application logic is further operable to automatically arrange at least two of said scanned images on said single page based on a number and size of scanned images on said single page.

21. The image capture device of claim 20, wherein said application logic is further operable to automatically arrange said at least two of said scanned images for storage as said single page, said single page being part of an image file.

22. The image capture device of claim 21, wherein said scanned images have different sizes.

23. The image capture device of claim 22, wherein at least one of said scanned images is rotated ninety degrees to fit on said single page.

24. The image capture device of claim 23, wherein said application logic is further operable to automatically rotate said at least one of said scanned images by ninety degrees.

25. The image capture device of claim 19, further comprising a memory device operable to store a plurality of predefined templates.

26. The image capture device of claim 19, wherein said application logic is further operable to automatically arrange said at least two scanned images based at least in part on an offset information specified by said selected template.

27. The image capture device of claim 26, wherein said offset information comprises an X-offset and a Y-offset.

28. The image capture device of claim 27, wherein said X-offset indicates a distance from a side of said single page and said Y-offset indicates a distance from a top of said single page.
